(19) United States
(12) Patent Application Publication
(10) Pub. No.: US 2005/0138393 A1
(43) Pub. Date: Jun. 23, 2005

(54) Determining user security level using trusted hardware device

(76) Inventors: David Carroll Challener, Raleigh, NC (US); Randall Scott Springfield, Chapel Hill, NC (US)

Correspondence Address: LALLY & LALLY, L.L.P., P. O. BOX 684749, AUSTIN, TX, 78768-4749, US

(21) Appl. No.: 10/746,783

(22) Filed: Dec. 22, 2003

(51) Int. Cl. H04K 1/00

(52) U.S. Cl. 713/186

(57) ABSTRACT

A system and method for enabling multiple levels of access to data on a system includes receiving an identifying metric and processing the metric by salting, hashing, encrypting, or a combination thereof the metric to obtain a table lookup value. The table lookup value is used to index a PW hash table to retrieve a security value. The security value is used to update the contents of a hardware register value such as a selected platform configuration register (PCR) of a Trusted Platform Module (TPM). A selected cryptographic key is then released to the user if the hardware register value matches a predetermined value. In this embodiment, each of a set of security values corresponds to a cryptographic key and each cryptographic key corresponds to one of the levels of access to data.

### BACKGROUND

1. Field of the Present Invention

The present invention is related to the field of data processing systems and more particularly data processing systems storing data requiring varying degrees of security.

2. History of Related Art

In many data processing applications, it is desirable to allow more than one person to use a particular data processing device and, more specifically, to allow users who have different levels of security to access a system. A device, for example, may store data having three different classifications—unclassified, classified, and top secret. A person with an unclassified level of security should not have access to classified or top secret data. It would be desirable to implement a system in which stored data could be classified into two or more levels of security and access to the data is controlled by the security level of the user. It would be further desirable if the implemented system leveraged security mechanisms already found in some systems.

### SUMMARY OF THE INVENTION

The objectives identified above are achieved with a method and system according to the present invention in which a trusted hardware device is used to control access to two or more cryptographic keys, each of which corresponds to a particular level of security. Access to the cryptographic keys is governed by a register of the trusted hardware device and, more specifically, access to each key requires that a corresponding value being found in a special purpose register of the hardware device. The special purpose register, in conjunction with the hardware device is capable of verifying the software state of the system. The value that is stored in the register is a function of a user identifying metric such as a password, biometric, or other security metric capable of verifying the user's identity. The identifying metric may be used to index a table that maps selected values of the metric to corresponding security values, which can be used to affect the contents of the register. Access to a cryptographic key is granted when the register has a corresponding value. In this manner, the system is capable of “mapping” a potentially large number of users into two or more security classes based on the identifying metric and to grant users access to data of a corresponding security classification. The hardware device is preferably compliant with standards of the Trusted Computing Group.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing system according to one embodiment of the present invention;

FIG. 2 is a block diagram of selected elements of the Trusted Platform Module of FIG. 1;

FIG. 3 is a block diagram of selected storage elements of the Trusted Platform Module of FIG. 2;

FIG. 4 is a conceptualized illustration of the operation of the trusted platform module according to an embodiment of the present invention;

FIG. 5 is a flow diagram of a method of storing various encryption keys in a trusted hardware device;

FIG. 6 is a flow diagram of a method of booting a data processing system according to one embodiment of the present invention; and

FIG. 7 is a conceptual diagram of a password hash table used in the system of FIG. 4.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking the present invention is concerned with storing different “levels” of data on a single machine such that users with a first security level clearance have access to data of the first level, users with a second security level clearance have access to data of the second level, and so forth. The described implementation uses a trusted hardware device such as a Trusted Computing Group (TCG) compliant Trusted Platform Module (TPM) to store multiple cryptographic keys. The cryptographic keys govern access to various levels of data. Each cryptographic key is released when a special purpose register in the hardware device achieves a corresponding value. The value of the register, in turn, is determined in a secured and trusted manner by a security metric that identifies the user's identity.

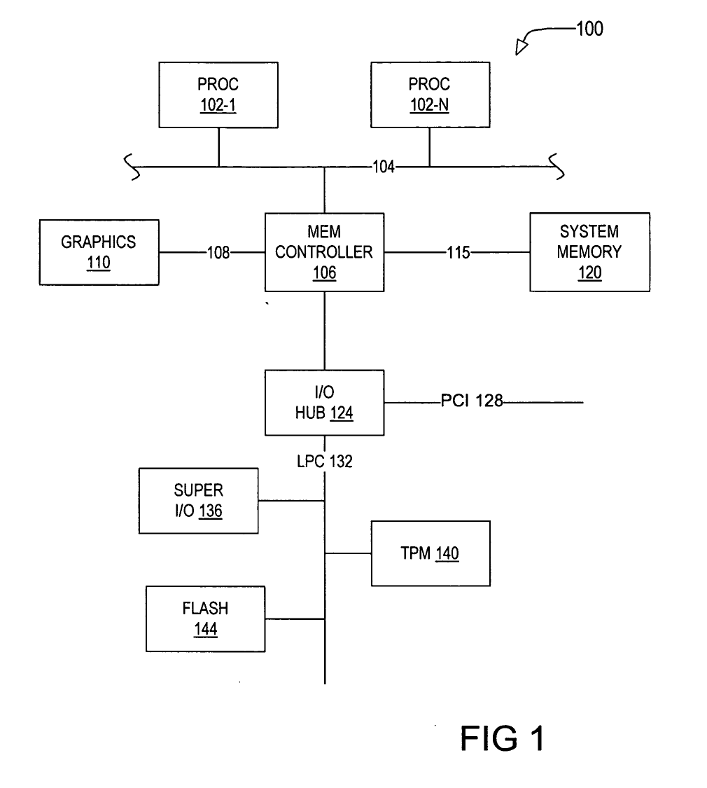

Referring now to FIG. 1, selected elements of a data processing system 100 according to one embodiment of the present invention are depicted. In the depicted embodiment, system 100 is exemplified by a desktop, notebook, or server class data processing system. As such, system 100 includes one or more central processing units (CPU's) 102-1 through 102-N (generically or collectively referred to as CPU(s) 102). Each CPU 102 connects to a memory controller 106 via a shared processor or host bus 104. A system memory 120 and a graphics card 110 are shown as connected to memory controller 106 via a memory bus 115 and a graphics bus (such as an Advance Graphics Protocol (AGP) bus) 108 respectively.

An I/O hub 124 connected to memory controller 106 provides multiple I/O or peripheral busses including a PCI bus 128 and a Low Pin Count (LPC) bus 132. Other peripheral busses provided by I/O hub 124, such as a USB, are not shown. LPC bus 132 is a high-speed interface between processors 102 and onboard peripheral functions (via a processor chip set that is not depicted). The LPC bus is a primary successor of the Industry Standard Architecture (ISA or X-bus) bus for connecting Super I/O (136), system management (not shown) and system BIOS firmware stored in a flash memory device (flash) 144 of FIG. 1.

One embodiment of the present invention leverages the facilities of a trusted platform module (TPM) 140 that is connected to LPC bus 132. TPM 140 is a trusted hardware device that includes an encryption engine and protected storage. In one embodiment, TPM 140 is compliant with the TCG Main Specification v. 1.1b (or later) and the TCG PC Specific Implementation Specification v. 1.0 (or later) from the Trusted Computing Platform Alliance (TCPA). Both of these specifications are well known in the field of secure computing and both are incorporated by reference herein. TPM 140 provides protected storage, protected signing of documents and other data (so that others can have confidence of the data's origin), and the ability for the BIOS to perform a trusted boot.

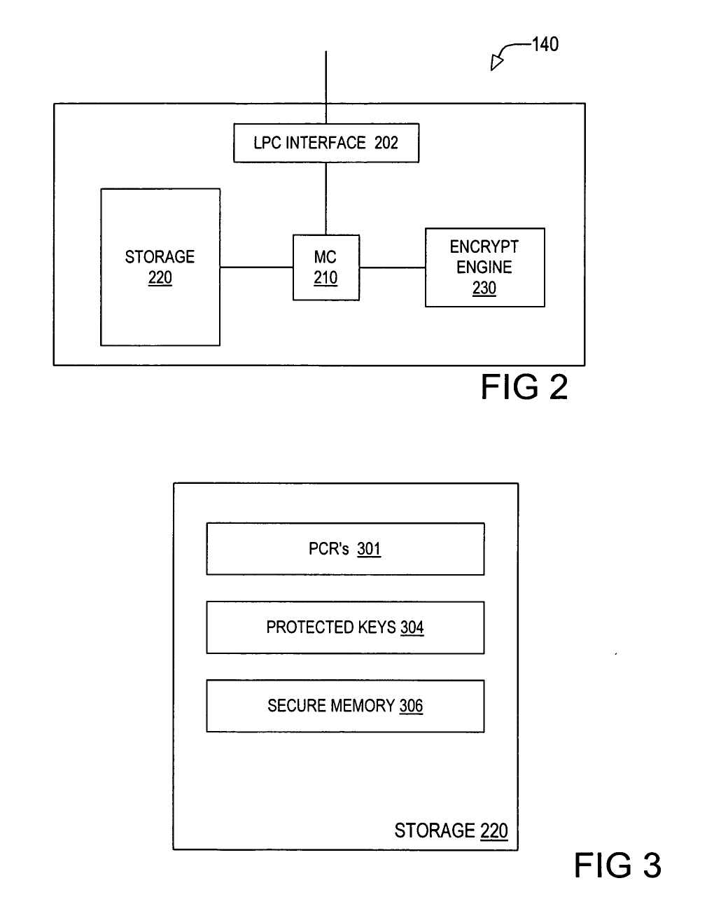

Referring to FIG. 2, one embodiment of TPM 140 includes an interface (202) to an LPC bus, a microcontroller 210, an encryption engine 230, and storage 220. As depicted in FIG. 3, storage 220 includes a set of platform configuration registers (PCR's) 301, a set of protected keys 304, and Secure Memory 306. Each TPM 140 implements a public key/private key encryption mechanism. Moreover, each TPM 140 has its own unique private key such that the TPM 140 can be used to authenticate the corresponding system to others. The protected keys 304 represent protected storage of TPM 140. The PCR's 301 are special purpose registers used to reflect the “measurement” of blocks of code. When a block of code is measured, the TPM performs a hash of the code segment using a secure hash algorithm, (SHA-1, for example) or a Rivset, Shamir, Adelman (RSA) algorithm. The measured value may then be “extended” into the PCR by hashing the measured value with the current value in the PCR such that the resulting PCR value is indicative of the code that was measured and the initial value of the register (i.e., the value of the register before measuring the code). The register can be used to verify the state or integrity of the system.

At least some of the PCR's 301 are used to achieve a trusted boot environment by measuring code that will be executed. In a typical sequence, the PCR's 301 are cleared to zero after power on or system reset. In a PC embodiment, a BIOS boot block represents the “root of trust in integrity measurement” to use TCPA terminology. This root of trust defines a point from which all other trust measurements originate. The boot block measures the BIOS code, before loading it, and extends this value into one of the PCR's. The BIOS code is then loaded and used to measure and extend into the PCR's the system hardware configuration, any option ROM's that are present, and an operating system (OS) loader. The OS loader might then measure at least a portion of the operating system (the kernel, for example) prior to loading it. At each point in the process, the BIOS can optionally compare the PCR value to a known value. If the value matches, then the process can continue under the assumption that no rogue processes have been encountered. Optionally, the Operating System (OS) can compare the PCR values to known values to determine system integrity. In this manner, the platform is established while maintaining an environment of trust.

The TCPA specification permits data to be “sealed”. When data is sealed using TPM 140, the TPM defines the environment in which access to the data is granted. TPM 140 defines the environment by specifying a value for a PCR 301 and/or other parameters (such as a password or pass phrase). Cryptographic keys, for example can be sealed using the TPM and these keys will only be available if a particular PCR value equals a predefined value. The present invention utilizes this capability of the TPM to enable users having different security levels to have access only to the data that is consistent with their respective security levels.

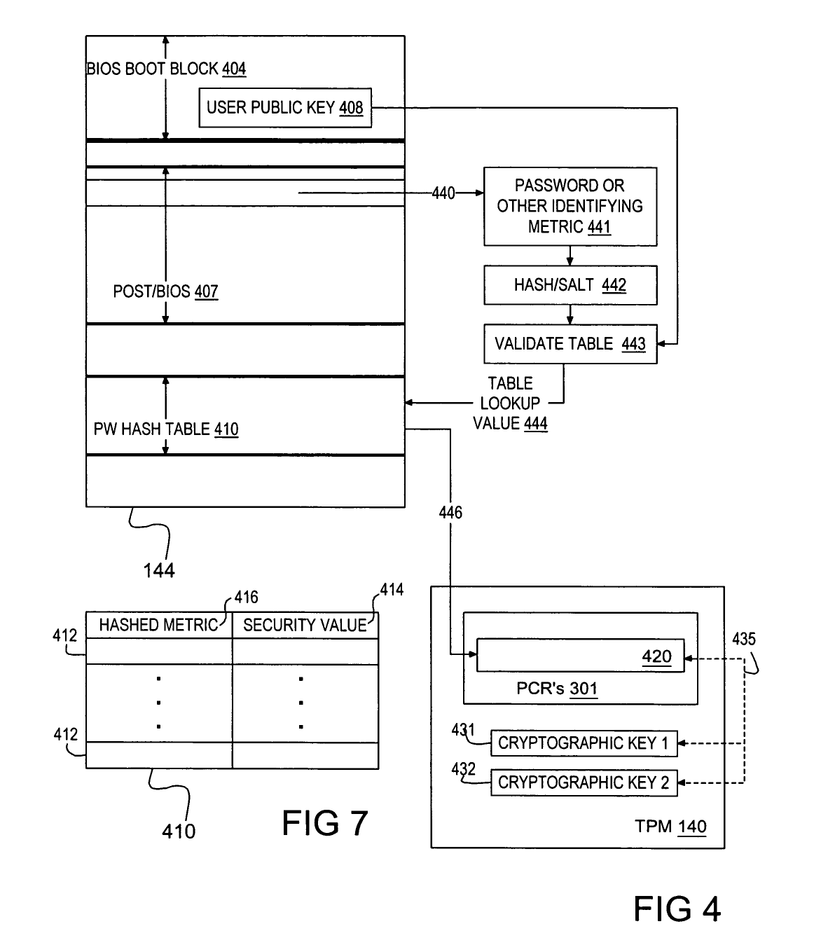

Referring to FIG. 4, a conceptualized depiction of flash 144 (of FIG. 1) for use with a TPM 140 (FIG. 1) according to one implementation of the present invention is shown. In the depicted embodiment, flash 144 includes BIOS boot block 404, POST/BIOS code 407, and a password (PW) hash table 410. The BIOS boot block 404 contains initialization code as well as a public key 408 used to validate the integrity of the PW Hash Table 410. In other implementations, public key 408 may be stored in TPM 140 or sealed using TPM 140 and stored in conventional fixed storage (not shown) of system 100.

When a system powers on, the BIOS boot block 404 takes control of the system (i.e., is the first code to execute). In addition to performing its initialization tasks, BIOS boot block 404 for use in a trusted system will “measure” POST/BIOS code 407 prior to jumping to this code. This methodology is defined in the TCG PC Specific Implementation Specification v. 1.0 (or later).

POST/BIOS code 407, according to the depicted embodiment, includes code that prompts (reference numeral 440) a user to provide a password or other identifying metric 441. The identifying metric, as an alternative to a password, may be a biometric identifier such as a fingerprint, handprint, iris scan, retinal scan, or the like. In the depicted embodiment, the identifying metric (or a numeric value indicative of the identifying metric) is processed to produce a table lookup value 444 used to index PW hash table 410.

The processing of identifying metric 441 includes performing a hash (block 442) on the identifying metric. In one embodiment, desirable for its ability to prevent a “dictionary” attack in which a series of alphanumerically sequential passwords are used in an attempt to discover the correct password, a relatively long alphanumeric string (called a salt) is appended or otherwise included in the user-provided metric prior to generating the hash value. The salt increases the number of characters in the password thereby decreasing the probability of a successful dictionary attack. The salt, when used, is likely stored in TPM 140 or sealed using TPM 140 to prevent its acquisition by an unauthorized party.

Because PW hash table 410 is used to authorize the release of cryptographic keys, it is important to verify (block 443) the integrity of PW hash table 410. In one embodiment, verification of PW hash table 410 is achieved using public key/private key encryption. A public key/private key pair is generated by an authorized user or administrator. The public key (reference numeral 408) is made available, such as by storing it in boot block 404. Prior to indexing PW hash table 410 with the salted/hashed password (i.e., table lookup value 444), the table is verified by decrypting, with public key 408, a digital signature stored in the table that was encrypted using the private key.

If the verification of PW hash table 410 is successful, table lookup value 444 is then used to index PW hash table 410. As shown in FIG. 7, PW hash table 410 includes a set of entries 412, each of which includes a hashed identifying metric 414, which may be encrypted as described below, and a corresponding security value 416. In the embodiment depicted in FIG. 4, password hash table 410 occupies a portion of Flash 144. In other embodiments, the password hash table may be stored on a removable medium and downloaded prior to booting.

If the hashed value stemming from the user provided password or other metric matches a metric value 414 for an entry 412 in PW hash table 410, the corresponding security value 416 is then “extended” (446) into a selected PCR, represented by reference numeral 420. Extending the security value into a PCR refers to the process in which a PCR value is modified by performing a hash on the PCR's current contents and the security value.

The use of authenticable PW hash table 410 provides a secure mechanism by which a large number of individual users can be “mapped” into a relatively small number of parameter groups. In other words, the number of entries 412 in table 410 can be made arbitrarily large to accommodate a large number of users. The possible values for each security value 414 are limited by the number of security classes desired. If a system is to recognize three levels of security or three classes of data (e.g., public, confidential, and classified), PW hash table 410 will generate a security value 414 having one of three possible values and each authorized user of the system will be mapped into one of the three available security classes.

Thus, in one embodiment, the system extends a value that is retrieved from table 410 into a selected PCR 420 of TPM 140. The value that is sealed into this PCR, according to the present invention determines the encryption/decryption keys to which the user will have access. In a three-tiered embodiment, for example, a first level of security corresponds to the security granted everyday users, a second level of security permits the appropriate set of users access to some (but not all) encryption/decryption keys, and a third level of security permits the appropriate set of users access to substantially all documents. If the selected PCR is also extended during the boot sequence after measuring the various blocks of code that are to be executed, the selected PCR, in addition to releasing a cryptographic key, can also be used to verify the state of system.

In FIG. 4, the value of two or more cryptographic keys 431 and 432 are sealed by the value in PCR 420. Although in this example cryptographic keys 431 and 432 are shown residing within TPM 140, the keys can be sealed into conventional persistent storage of the system, in which case the process of unsealing them will provide the correct key material. The cryptographic key that is available to a user depends on the value that is stored in PCR 420. Cryptographic key 431 is released (unsealed) if PCR 420 has a first value while key 432 is released if PCR 420 has a second value. Using this technique, system 100 uses TPM 140 to implement a plurality of sealed cryptographic keys, each associated with a corresponding security level and one of which is released when a particular value is extended into a the selected PCR. These keys are freed up to the user if the identifying metric provided by the user, in conjunction with PW hash table 410, produces a value that matches an entry 412 in the password hash file 410.

Portions of the invention may be implemented as a set or sequence of computer executable instructions (software) for using a secure platform device to enable multiple levels of security to exist simultaneously in a single machine. In such embodiments, the software instructions may be stored on a persistent media such as a hard disk, CD ROM, or the like. At other times, the computer instructions may reside in a volatile memory structure such as the system memory and/or a cache memory. In other embodiments, the invention comprises a service of enabling a system to use a secure platform device to enable the multiple levels of security. The software and service embodiments are both illustrated with a common set of flow diagrams showing the performance of the software when executed and the functionality that will be enabled by the service.

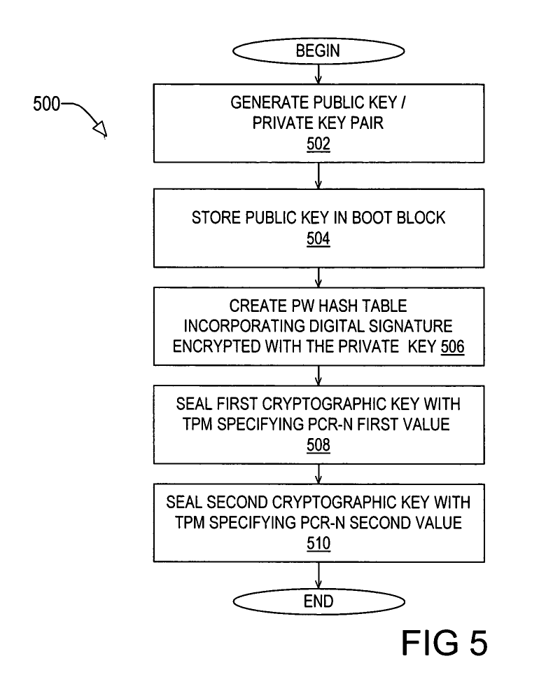

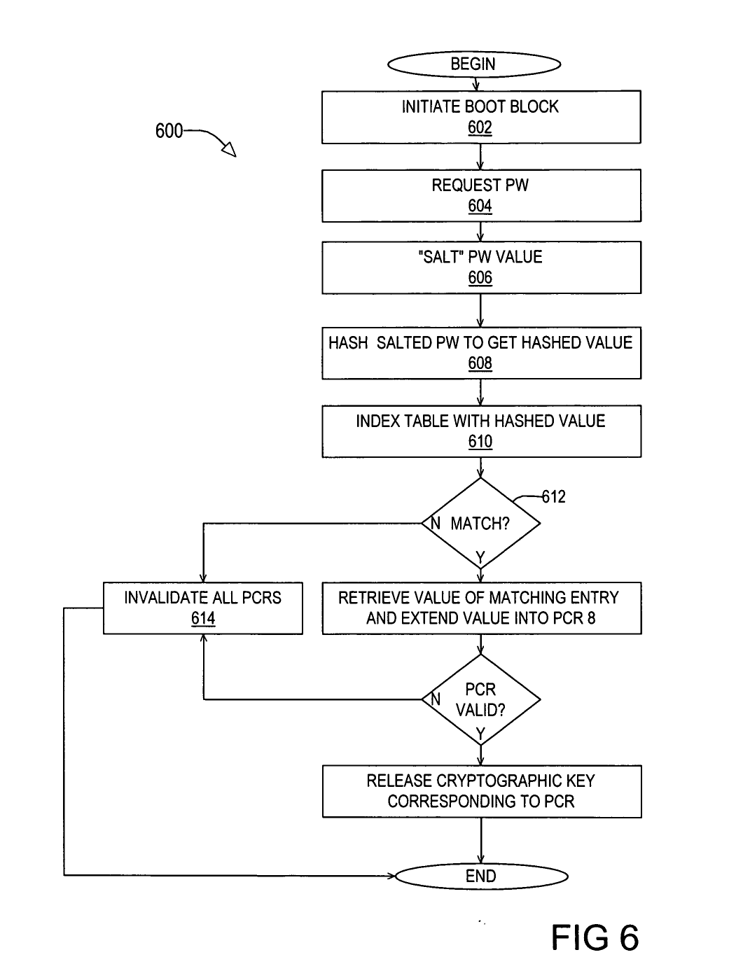

Referring now to FIG. 5 and FIG. 6, flow diagrams of methods for implementing and using the secure and flexible techniques of the present invention are depicted. In the depicted embodiment, a method 500 (FIG. 5) is invoked to initialize a public key and a password hash table and to seal one or more cryptographic keys using the TPM are depicted. The depicted embodiment of method 500 includes creating a password hash table such as hash table 410 that is capable of being authenticated. In the depicted embodiment, this is achieved by generating (block 502) a public key/private key pair. The public key 408 is then stored (block 504) in secure storage such as within the boot block 404 of flash memory device 144. In other embodiments, the public key 408 may be stored in secure storage of TPM 140. The password hash table 410 is then generated (block 506). The password hash table uses the generated public key private key pair so that hash table 410 may be verified. Specifically, in the process of generating the PW Hash Table 410, the private key 502 is used to generate a digital signature of the table. The digital signature enables the lookup code to validate the integrity of PW Hash Table 410 by decrypting the table's digital signature using public key 408 prior to using the data.

Method 500 further includes sealing first and second cryptographic keys using TPM 140. This first key is sealed (block 508) by associating the first key with a first value of a selected PCR 420 while second key is sealed (block 510) by associating the second key with a second value of PCR 420. The choice of a particular PCR 420 in the depicted example is implementation specific. In a PC environment, the use of PCR's 0-7 of TPM 140 is defined by the specification while the remaining PCR's are available for general purpose use.

Once the cryptographic keys have been sealed to a particular PCR value using TPM 140, operation may begin as depicted in FIG. 6. FIG. 6 depicts a method 600 for implementing multiple levels of access to data in a data processing system. Generally, method 600 includes receiving an identifying metric (441 of FIG. 4) and processing the metric by salting, hashing, (or a combination thereof) the metric to obtain a corresponding table lookup value 444. Table lookup value 444 is used to index PW hash table 410 to retrieve a security value. The security value is used to update the contents of a hardware register value such as the selected PCR 420. A selected cryptographic key is then released to the user if the hardware register value matches a predetermined value. In this embodiment each of a set of security values corresponds to a cryptographic key and each cryptographic key corresponds to one of the levels of access to data.

More specifically with reference to FIG. 6, a boot block is executed (block 602), typically in response to a power on or system reset. The boot block code measures the POST/BIOS code 407 and then jumps to that code. The POST/BIOS code then prompts (block 604) the user to enter a password or other metric (a password is assumed in the remaining discussion). After the user enters a password, a salt is appended to the password in block 606. In other embodiments, salting of passwords in block 606 is bypassed. In the depicted embodiment, the salted password value is hashed (block 608) to produce a table lookup value and the PW hash table 410 is validated (block 609) using the public key 408. Assuming that the validation if the PW hash table is successful, the table lookup value is used to index (block 610) the password hash file 410. If no match is detected between the table lookup value and an entry in the PW hash table, the index table returns a value that forces all registers to be invalidated (block 614). If a match is detected (block 612), the matching value is retrieved from the password hash value and, with or without decryption, extended into the appropriate PCR (block 616). With the appropriate value extended into the correct PCR, a cryptographic key corresponding to the PCR value will become available thereby allow the corresponding user to access system data that shares the user's security clearance (i.e., data that may be accessed with the available cryptographic key). Using an example to illustrate, one implementation of the invention releases one of three available encryption keys based on the value sealed into a particular PCR. The password hash table maps all recognized user passwords into one of the three available encryption classes by returning a value that, when extended into a PCR, leaves the PCR with one of three possible values.

It will be apparent to those skilled in the art having the benefit of this disclosure that the present invention contemplates a mechanism enabling varying levels of user authorization levels securely. It is understood that the form of the invention shown and described in the detailed description and the drawings are to be taken merely as presently preferred examples. It is intended that the following claims be interpreted broadly to embrace all the variations of the preferred embodiments disclosed.

1. A method of implementing multiple levels of access to data in a data processing system, comprising:
receiving an identifying metric and processing the metric to obtain a corresponding table lookup value;
using the table lookup value, indexing a table to retrieve a security value;
using the security value to update the contents of a hardware register value; and
releasing a selected cryptographic key to the user if the hardware register value matches a predetermined value, wherein each of a set of security values corresponds to a cryptographic key and each cryptographic key corresponds to one of the levels of access to data.

2. The method of claim 1, wherein the identifying metric is a biometric identifier.

3. The method of claim 1, wherein the identifying metric is a password entered by the user during boot sequence.

4. The method of claim 3, wherein processing the metric comprising performing a hash of the password to produce the table lookup value.

5. The method of claim 3, wherein processing the metric comprises adding a salt to the password and hashing the resulting string.

6. The method of claim 1, further comprising, validating the table using a digital signature prior to indexing the table with the table lookup value.

7. The method of claim 1, wherein using the security value to update the contents of a hardware register includes using the security value to extend the contents of a platform configuration register in a trusted hardware device and using the contents of the extended platform configuration register to select said one of said plurality of cryptographic keys.

8. A data processing system, comprising:
a processor and a system memory accessible to the processor;
a trusted hardware device accessible to the processor, wherein the trusted hardware device implements a unique public/private key pair to authenticate the trusted hardware device;
computer code means for receiving a metric suitable for identifying a user and processing the identifying metric to obtain a table lookup value;
code means for using the table lookup value to index a table;
responsive to the table lookup value matching an entry in the table, code means for retrieving a security value associated with the matching entry; and
means for updating a hardware register based on the security value; and
code means for releasing a cryptographic key corresponding to the hardware register if the hardware register value matches a predetermined value.

9. The system of claim 8, wherein the trusted hardware device enables the encryption of a set of cryptographic keys and specifies the system software state required to decrypt the set of cryptographic keys.

10. The system of claim 8, wherein the code means for receiving the metric includes code means for receiving a password and for hashing the password.

11. The system of claim 10, wherein the code means for receiving the metric further includes code means for appending a salt value to the password prior to hashing.

12. The system of claim 8, wherein the table includes a set of entries wherein each entry corresponds to a user password and further wherein each entry includes one of a set of security values, wherein each security value corresponds to a level of security.

13. The system of claim 8, further comprising code means for validating the table using a digital signature prior to indexing the table with the table lookup value.

14. The system of claim 8, wherein updating the hardware register includes verifying the state of the system by extending a platform configuration register with the security value.

15. A service for enabling multiple levels of security in a data processing system, comprising:
enabling the generation of an authenticatable table having a set of entries, each entry corresponding to a table lookup value derived from an identifying metric associated with a user and each entry including one of a set of security values corresponding to the table look up value;
enabling the system to receive an identifying metric associated with the user;
enabling the system to generate the table lookup value from the identifying metric;
enabling the system to index the table using the table lookup value to retrieve the corresponding security value;
enabling the system to update a platform configuration register based on the security value; and
enabling the system to release a cryptographic key associated with the platform configuration register value responsive to determining that the platform configuration register value matches one of a set of platform configuration register values.

16. The service of claim 15, wherein each security value of the set of security values corresponds to a security level defining access to date.

17. The service of claim 16, wherein enabling the system to received an identifying metric includes enabling the system to receive a user password during a boot sequence of the system.

18. The service of claim 17, wherein, enabling the system to generate the table lookup value comprises enabling the system to generate a hash value based on the password.

19. The service of claim 18, wherein, enabling the system to generate the table lookup value further comprises adding a salt to the password prior to generating the hash value.

20. The service of claim 19, wherein, the salt is stored in trusted storage.

21. The service of claim 15, wherein enabling the system to index the table using the table lookup value includes enabling the system to validate the table using a digital signature prior to indexing the table with the table lookup value.
